(19) United States
(12) Patent Application Publication
(10) Pub. No.: US 2026/0049492 A1
(43) Pub. Date: Feb. 19, 2026

(54) DECK JET ASSEMBLY WITH INTEGRATED LIGHTING

(71) Applicant: BELLSON ELECTRIC PTY LTD, Caringbah NSW (AU)

(72) Inventor: David John Sanson, Taren Point NSW (AU)

(21) Appl. No.: 19/300,187

(22) Filed: Aug. 14, 2025

Related U.S. Application Data
(60) Provisional application No. 63/682,966, filed on Aug. 14, 2024.

(51) Int. Cl. E04H 4/12; E04H 4/14; F21S 8/02; F21V 21/04; F21W 121/02

(52) U.S. Cl. CPC E04H 4/1209; E04H 4/148; F21S 8/028; F21V 21/04; F21V 2200/00; F21W 2121/02

(57) ABSTRACT

A deck jet assembly has a pop-up nozzle configured to receive a quantity of water from an inlet pipe. A lighting device is positioned substantially directly below the pop-up nozzle, wherein the lighting device is positioned to emit a quantity of light to illuminate a laminar flow through the pop-up nozzle.

### CROSS REFERENCE TO RELATED APPLICATION

This application claims benefit of U.S. Provisional Application Ser. No. 63/682,966 entitled, “Deck Jet Assembly with Integrated Lighting” filed Aug. 14, 2024, the entire disclosure of which is incorporated herein by reference.

### FIELD OF THE DISCLOSURE

The present disclosure is generally related to illuminated water features and more particularly is related to deck jet assemblies with integrated lighting.

### BACKGROUND OF THE DISCLOSURE

Water features are commonly used to both enhance the appearance of a pool, spa, or similar environment, as well as to make a pool experience more enjoyable for children and adults alike. Similarly, pool related lighting features may add extra ambiance and style. Some pool features have both a water feature component and a lighting feature component, creating a two in one system where the combination of the water feature with lighting provides enhanced aesthetics. Some examples include fountains with a light device positioned near the base and angled to shine light on water spraying into the air. However, in this case, there remains a portion of the water that remains unlit from the light device, and furthermore, the illumination of the water feature is dependent on ideal weather conditions and pre-positioning the angle of the light device relative to the fountain. Conventionally, lighting features and water features, although marketed as together, are two separate systems that are configured to function together.

### SUMMARY OF THE DISCLOSURE

Embodiments of the present disclosure provide an apparatus for a deck jet assembly with integrated lighting. Briefly described, in architecture, one embodiment of the system, among others, can be implemented as follows. A deck jet assembly has a pop-up nozzle configured to receive a quantity of water from an inlet pipe. A lighting device is positioned substantially directly below the pop-up nozzle, wherein the lighting device is positioned to emit a quantity of light to illuminate a laminar flow through the pop-up nozzle.

In one aspect, the deck jet assembly has a housing, and the inlet pipe, the lighting device, and the pop-up nozzle interface with the housing.

In another aspect, the pop-up nozzle has a retracted state and a deployed state. In the deployed state, the pop-up nozzle extends beyond an exterior surface of the housing a predetermined distance.

In this aspect, the pop-up nozzle sits substantially flush with an upper surface of a pool deck when the pop-up nozzle is in the retracted state.

In another aspect, the housing is positionable at least partially below an upper surface of a pool deck.

In another aspect, the housing also has an upper portion connected to a lower portion by a gasket, wherein the upper portion contains a rim positionable at least partially below an upper surface of a pool deck, and wherein the upper portion of the housing is separable from the lower portion of the housing along the gasket.

In this aspect, a decking layer is positioned above the upper portion of the housing and substantially level with the upper surface of the pool deck.

In another aspect, a portion of the quantity of light emitted from the lighting device illuminates the laminar flow along at least a portion of a length thereof.

In yet another aspect, the deck jet assembly includes a funnel connected to an internal sidewall of a housing, wherein the funnel directs the quantity of water from an inlet pipe into the housing and toward the pop-up nozzle.

In this aspect, the deck jet assembly may also include a filter positioned within the housing between the inlet pipe and the funnel, wherein the filter forms the laminar flow with the quantity of water, wherein the laminar flow extends beyond the pop-up nozzle.

In this aspect, the filter may have an opening configured to receive at least one of the lighting device or an electrical wire electrically connected to the lighting device.

In another aspect, a filter is positioned within a portion of the funnel, wherein the filter forms a laminar flow with the quantity of water, wherein the laminar flow extends beyond the pop-up nozzle.

In addition, the present disclosure may also be seen as providing a deck jet system for lighting a pool deck, the deck jet system having an inlet pipe configured to receive a quantity of water. A pop-up nozzle is fluidically connected to the inlet pipe. A lighting device is positioned substantially directly below the pop-up nozzle, wherein the lighting device is positioned to emit a quantity of light to illuminate a laminar flow through the pop-up nozzle. The deck jet system also has a housing, wherein the inlet pipe, the lighting device, and the pop-up nozzle interface with the housing. The pop-up nozzle has a retracted state and a deployed state. In the deployed state, the pop-up nozzle extends beyond an exterior surface of the housing a predetermined distance.

In one aspect, the laminar flow extends beyond the pop-up nozzle when the pop-up nozzle is in the deployed state.

In another aspect the housing also has an upper portion connected to a lower portion by a gasket. The upper portion contains a rim positionable at least partially below an upper surface of a pool deck. The upper portion of the housing is separable from the lower portion of the housing along the gasket.

In another aspect, the deck jet system also has a funnel connected to an internal sidewall of a housing. The funnel directs the quantity of water from the inlet pipe into the housing and toward the pop-up nozzle. Also, the deck jet system includes a filter positioned within the housing between the inlet pipe and the funnel. The filter forms the laminar flow with the quantity of water. The laminar flow extends beyond the pop-up nozzle.

In this aspect, the filter includes an opening configured to receive at least one of the lighting device or an electric wire electrically connected to the lighting device.

The present disclosure may also be seen as providing a system to light pool water features. The system has a single water source fluidly connecting a first deck jet assembly to a second deck jet assembly. At least one of the first deck jet assembly or the second deck jet assembly has an inlet pipe configured to receive water from the single water source. A pop-up nozzle is fluidically connected to the inlet pipe. A lighting device is positioned substantially directly below the pop-up nozzle, wherein the lighting device is positioned to emit a quantity of light to illuminate a laminar flow through the pop-up nozzle. In one aspect of the system, the single water source is fluidly connected to the first deck jet and the second deck jet in series.

Another aspect of the system includes a parallel fluid connection between the single water source and the first deck jet and the second deck jet.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is an isometric view illustration of a deck jet assembly, in accordance with the present disclosure.

FIG. 2 is a cross-sectional view illustration of a deck jet assembly, in accordance with the present disclosure.

FIG. 3 is a cross-sectional view illustration of a deck jet assembly having a water filter, in accordance with the present disclosure.

FIG. 4 is a detailed isometric view illustration of a filter used with the deck jet assembly, in accordance with the present disclosure.

FIG. 5 is an isometric view illustration of a deck jet assembly, in accordance with the present disclosure.

### DETAILED DESCRIPTION

Specific examples of components and arrangements are described below to simplify the present disclosure. These are merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Deck jets are an example of a water feature used to inject water into pools, such as home swimming pools. Deck jets may emit an arcing fountain of water into a pool.

A laminar flow is made by directing a fluid to move along a substantially parallel path. Water is normally supplied with a mostly turbulent flow profile rather than a laminar flow. Usually, large pressure vessels are required to change a fluid from a turbulent flow profile into a laminar flow. A laminar flow of a fluid, like water, in air may function to direct light within the laminar flow. The light within the flow may be partially or totally internally reflected and refracted within the laminar flow, so a person observing the laminar flow might see the flow as clear (little or no light escaping the flow) or glowing with the partially internally reflected and refracted light. A bended path rather than a linear path may enhance the partial internal reflection and refraction of the light within a laminar flow. A laminar flow can “trap” or direct light so that all of the path of the laminar flow is lit until the laminar flow is disrupted. This is in contrast to lighting a laminar flow from outside the laminar flow, where only a portion of the path of the flow might be illuminated and much of the light not directed to the path of the laminar flow. When the laminar flow is broken or disrupted into a turbulent flow, such as when a laminar flow meets a surface like the top of the water in a pool, the laminar flow may release the light, creating an aesthetic pattern or appearance.

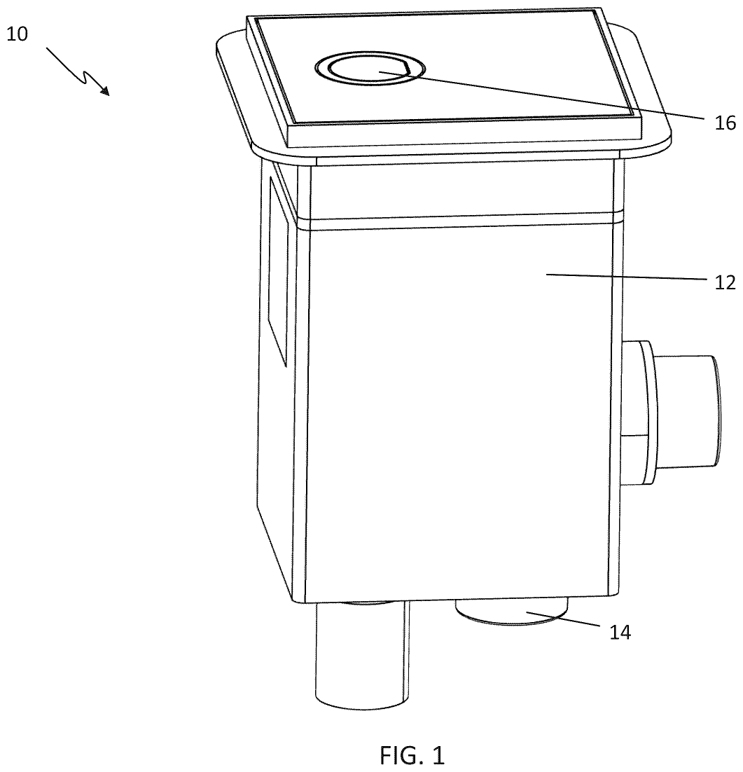

When light is directed within a laminar flow, the lighting of the laminar flow is not dependent on ideal weather conditions which would interfere with the impingement of an external light on the laminar flow. Weather conditions may interfere with the path of the light directly, like fog scattering the light before it reaches the laminar flow, or with the position of the laminar flow, like wind changing the location of the laminar flow, which may move the laminar flow out of the light path. A lighting device positioned within the laminar flow may also light the entire laminar flow while the lighting device itself remains stationary. The lighting of the laminar flow is also not dependent on pre-positioning the angle of the lighting device relative to the water feature because a quantity of light from within the laminar flow rather than external to the flow serves to light or trace the path of the laminar flow. One way of creating a lighted laminar flow is to position the lighting device within the water feature itself, so that the water feature and lighting of the water feature may be marketed and sold together rather than as a separate water feature and lighting device. FIG. 1 is an isometric view illustration of a deck jet assembly 10. The deck jet assembly 10 may have a housing 12, and the internal components of the deck jet assembly 10 may be contained within or interface with the housing 12. Certain elements of the deck jet assembly 10 may extend beyond the housing 12 or may otherwise be configured to extend out from the housing 12. For example, the deck jet assembly 10 may have an inlet pipe 14 interfacing with and extending out from a side of the housing 12. The inlet pipe 14 may be configured to receive water from a water source. A pop-up nozzle 16 may be positioned on and interface with a side of the housing 12, such as the top side, and may be fluidically connected to the inlet pipe 14 via a fluid connection within the housing 12. As such, the pop-up nozzle may be configured to receive a quantity of water from an inlet pipe, and water entering the deck jet assembly 10 from the inlet pipe 14 may exit the deck jet assembly 10 through the pop-up nozzle 16. Pop-up nozzle 16 may have a retracted state and a deployed state. In a retracted state, the pop-up nozzle 16 may sit substantially flush or level with an exterior surface of the housing 12, such as the top surface thereof, or an upper surface of a pool deck when the deck jet assembly 10 is not in use or when a quantity of water is not present. When water enters the inlet pipe 14 at a sufficient pressure, the pop-up nozzle 16 may extend into the deployed state a predetermined distance, such that at least a portion of the pop-up nozzle 16 extends beyond an exterior surface of the housing 12, and thus allows water to exit the deck jet assembly 10.

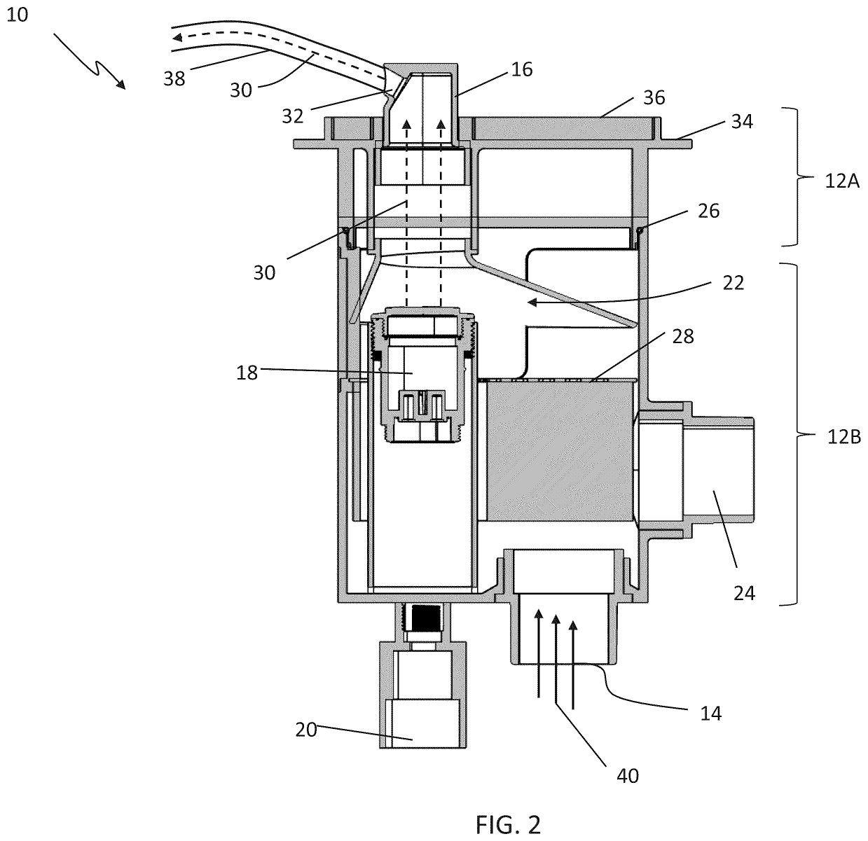

FIG. 2 is a cross-sectional view illustration of the deck jet assembly 10 of FIG. 1, in accordance with the present disclosure. In particular, FIG. 2 illustrates internal components of the deck jet assembly 10 with a pop-up nozzle 16 in the extended position. Within the housing 12, represented in FIG. 2 as 12A and 12B, which together may form housing 12, a lighting device 18 may be positioned substantially directly below the pop-up nozzle 16. The lighting device 18 may interface with housing 12 directly or through other internal components. The lighting device 18 may be positioned to emit a quantity of light 30 to illuminate a laminar flow 38 through the pop-up nozzle 16 and through a spout 32. In accordance with this disclosure, the lighting device 18 positioned substantially directly below the pop-up nozzle 16 may be understood to mean that the lighting device is positioned such that a quantity of light 30 is able to illuminate the laminar flow 38 through the pop-up nozzle 16 through the spout 32. This may only mean that a certain portion of the quantity light emitted 30 from the lighting device 18 need travel through the laminar flow 38 out of the spout 32. For example, as shown in FIG. 2, the lighting device 18 may be positioned directly below a footprint of the pop-up nozzle 16, and the axes of the lighting device 18 and nozzle 16 are concentric. In other examples, the lighting device 18 may be positioned slightly off center from a footprint of the pop-up nozzle 16.

Water entering 40 through the inlet pipe 14 may be from a pipe, hose, or any other water source which can connect to the inlet pipe 14. The water entering 40 may be turbulent in nature and on passing through the inlet pipe 14 and through the housing 12, water exiting may exit from the pop-up nozzle 16 in a laminar flow 38. The deck jet assembly 10 may convert the flow of the water from turbulent at the inlet pipe 14 to laminar flow 38 at or before the spout 32. The positioning of the lighting device 18 may allow for a portion of the quantity of light 30 emitted from the lighting device 18 to trace or track along the laminar flow 38 of the water exiting, and illuminates the laminar flow 38 along at least a portion of a length of the laminar flow 38, which may extend beyond the pop-up nozzle 16. That is, the stream of water exiting pop-up nozzle 16 may appear to be illuminated intrinsically through internal reflection or refraction of the quantity of light 30 within laminar flow 38.

The deck jet assembly 10 may have additional internal components within the housing 12 to aid with transitioning the turbulent flow of water entering 40 into a laminar flow 38 of water exiting. Additionally, these components may aid in positioning the lighting device 18 substantially under the pop-up nozzle 16. One such component may be a funnel 22 connected to the internal sidewalls of the housing 12. The funnel 22 may direct or otherwise aid in directing the flow of the quantity of water from the inlet pipe 14 into the housing 12 and towards the pop-up nozzle 16. The lighting device 18 may be positioned to connect to the electrical conduit 20 and may be substantially watertight, such that an electrical connection may travel into the electrical conduit 20 and electrically connect with the lighting device 18, without the electrical connection coming into contact with the water in the housing 12. The electrical connection may be any wire of any diameter that is sufficient to create a watertight seal where the electrical connection enters the housing 12. In one example, the electrical conduit 20 may have a port or connector located externally on the housing 12 such that a power source can be removably connected or fastened to the electrical conduit 20. Electrical conduit 20 may be positioned proximate to a central location in the bottom of the housing 12 to optimize the position of the inlet pipe 14 and improve the laminar flow 38 of water. A filter 28 may be positioned within housing 12 between inlet pipe 14 and pop-up nozzle 16.

The lighting device 18 may be any lighting device 18 that may sufficiently illuminate the laminar flow 38 exiting the pop-up nozzle 16. This may include incandescent bulbs, single color LEDs, or multicolored LEDs. In some examples, the lighting device 18 may include additional circuitry to allow for a user to change the colors of the lighting by a remote and/or through a smart device such as a smartphone that may be wirelessly connected to the lighting device 18 through either one of short-range wireless connection or long-range wireless connection. For example, a pulse-width modulation technique may be used to provide color control of the lighting device 18.

The deck jet assembly 10 may be positionable at least partially below an upper surface of a pool deck, such as, for example, where a top surface of the deck jet assembly 10 is flush with a top surface of the pool deck. The deck jet assembly 10 and housing 12 thereof may be watertight so as to avoid any flooding or water damage under the pool deck. To access and service internal components, such as the lighting device 18, within the housing 12, it may be preferred that the housing 12 be constructed in two pieces. In the example where the housing 12 is constructed in two pieces, there may be a gasket 26 between an upper portion of the housing 12A and a lower portion of the housing 12B to create a watertight seal. The upper portion of the housing 12A may be connected to a lower portion of the housing 12B by gasket 26. The upper portion of the housing 12A may contain a rim 34 positionable at least partially below an upper surface of a pool deck. The upper portion of the housing 12A may be separable from the lower portion of the housing 12B along the gasket 26. The gasket 26 may prevent water from leaking outside the deck jet assembly 10 in amounts that may damage the pool deck.

The upper portion of the housing 12A may have a rim 34 or flange for installation at least partially below an upper surface of the pool deck, depending on the type of pool decking used. The rim 34 may remain stationary to the deck itself, such that the deck jet assembly 10 cannot be pulled out using direct vertical force, but rather may require the deck jet assembly to be tilted and shifted for removal. The rim 34 may have holes for receiving various types of fasteners to secure the deck jet assembly 10 to the pool deck. In some examples, the upper portion 12A of the housing 12 may also be secured under the pool deck using other fastening methods.

The deck jet assembly 10 may be installed with the decking layer 36 positioned above the upper portion of the housing and substantially level with the upper surface of the remainder of the pool deck. Substantially level may be understood to mean that the decking layer 36 is visibly level with the pool deck, or otherwise aesthetic in appearance, such that it is not apparent that there is a larger structure under the pool deck, or such that the top portion 12A of the deck jet assembly 10 is otherwise not protruding from the surface of the pool deck. The decking layer 36 may be made of any material, preferably, the material and color thereof matches the material and color of the pool deck. For instance, a travertine pool deck may have a portion of travertine cut to fit as the decking layer 36, such that the decking is consistent in appearance. Deck jet assembly 10 may be positioned separated from an edge of the pool deck. When the laminar flow 38 extends beyond pop-up nozzle 16, laminar flow 38 may extend beyond the edge of the pool deck and into the surface of a swimming pool or pond, creating a fountain effect of water from the deck jet assembly 10 into the swimming pool or pond.

In another example in accordance with the present disclosure, a system to light pool water features may include a single water source fluidly connecting a first deck jet assembly 10 to a second deck jet assembly 10. Each deck jet assembly 10 may be fluidly connected in series to the single water source and to the other deck jet assemblies 10 through a connector pipe 24. The connector pipe 24 may connect to the housing 12 and may generally provide an opening into an area inside the housing 12 containing water. The connector pipe 24 may allow a first deck jet assembly to fluidly connect to a second deck jet assembly. In some examples, an external pipe may fluidly connect to the connector pipe 24 to fluidly connect one or more deck jet assemblies 10 to one another. This may be beneficial in the case of installing two or more deck jet assemblies 10, where each of the two or more deck jet assemblies 10 are spaced at a distance greater than the length of the connector pipe 24. An external pipe may allow for the deck jet assembly 10 to be spaced as desired by a user based on their specific pool deck and dimensions thereof. Lighting device 18 within the first deck jet assembly may be independently controllable as described above from lighting device 18 within the second deck jet assembly. For instance, lighting device 18 within the first deck jet assembly may be independently controllable to turn on or off or to emit a color of the quantity of light that is of a different wavelength than the color of the quantity of light emitted by lighting device 18 within the second deck jet assembly. The first deck jet assembly and the second deck jet assembly may also be independently controllable to extend laminar flow 38 beyond the pop-up nozzle 16.

Similarly, the single water source of deck jet assembly 10 may be fluidly connected in parallel to the first deck jet assembly 10 and the second deck jet assembly 10, where, for example, a single water source may fork into multiple pipes and each of the multiple pipes may fluidly connect to the connector pipe 24 of deck jet assembly 10, which may receive water from the single water source through its inlet pipe 14. This configuration may be beneficial over each deck jet assembly 10 having its own water source, as it will ensure relative and substantially equal pressures between each deck jet assembly 10, and thus, ensures that the spouts 32 of each pop-up nozzle 16 are consistent and substantially equal in water pressure.

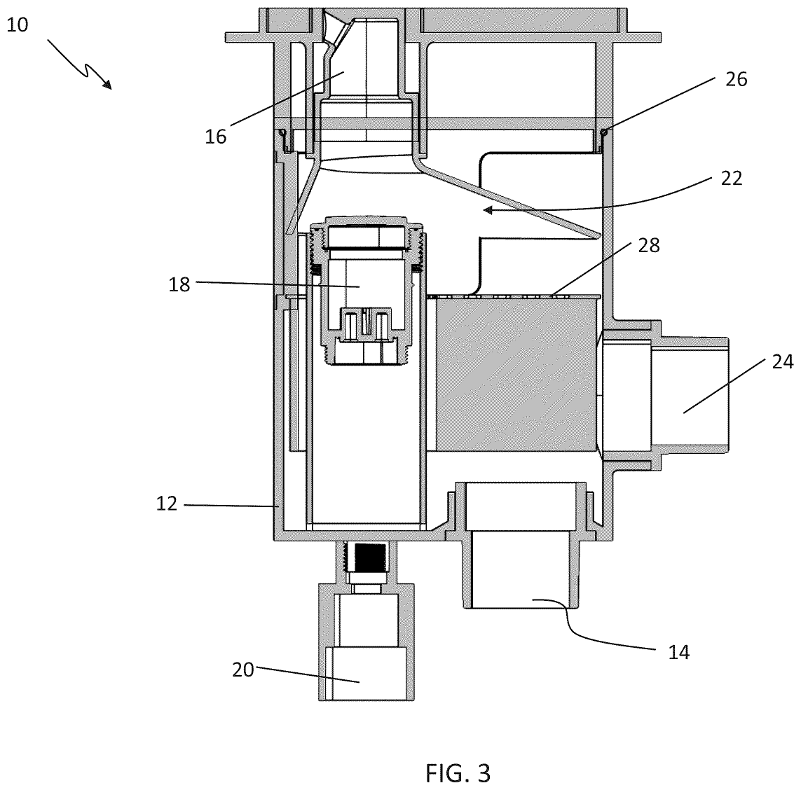

FIG. 3 is a cross-sectional view illustration of a deck jet assembly 10 having a water filter 28, in accordance with the present disclosure. In particular, the deck jet assembly 10 depicted in FIG. 3 may have a filter 28 positioned within the housing 12 at a position between the inlet pipe 14 and the funnel 22. In some examples, the filter 28 may be positioned within a portion of the funnel 22. The filter 28 may be any filter which is capable of disrupting the turbulent flow of a quantity of water incoming from the inlet pipe 14 and forming laminar flow 38 with the quantity of water, which laminar flow 38 may extend beyond the pop-up nozzle 16. In some examples, the filter 28 may be a plastic woven filter 28. FIG. 3 contains many of the same features, structures, and functions as described relative to FIGS. 1-2, which are not restated for FIG. 3 for brevity in disclosure. Creation of laminar flow 38 with filter 28 may be preferred over use of a pressure vessel to create laminar flow 38 because of the size of the pressure vessel, which may be larger than 6 inches by 6 inches, or a similar compact space. Space within or under a pool deck may be limited due to plumbing beneath the pool deck and structural requirements for the pool deck. In one example, it may be preferred that a length and a width of the housing 12 of the deck jet assembly 10 does not exceed 6 inches by 6 inches, which may not be possible with a pressure vessel. Limiting the length and the width of the housing 12 may also offer advantages to installation of the deck jet assembly 10.

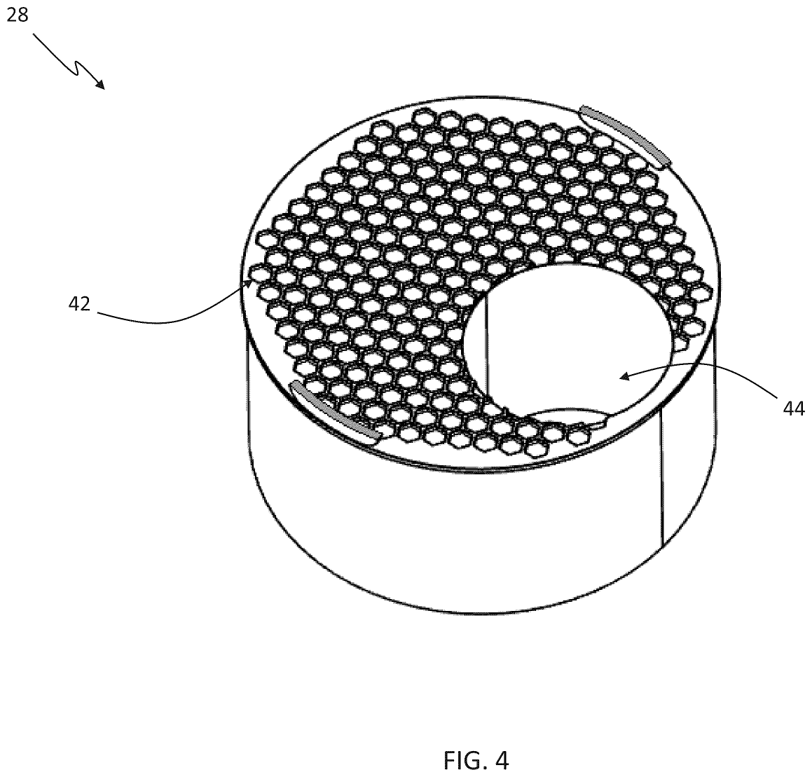

FIG. 4 illustrates a close-up isometric view of the filter 28 in accordance with the present disclosure. As shown, the filter 28 may be formed from a plurality of pores 42 or apertures. With reference to FIGS. 2-3, the filter 28 may have an opening 44 configured to receive the lighting device 18, or an electrical wire electrically connected to the lighting device 18. The plurality of pores 42 may be formed around the opening 44 and within the bounds of the filter 28. The plurality of pores 42 may extend for the entirety of the height of the filter, allowing turbulent water to enter the filter 28 from one end, where the turbulent flow is disrupted, and exit from the other end as a laminar flow 38. The laminar flow 38 of the water may extend beyond the pop-up nozzle. Of note, the pores 42 of the filter 28 need not be honeycomb shaped or in a honeycomb configuration. While this configuration may optimize use of surface area and volume of the filter 28 body, the pores 42 may be any shape and in any configuration on the filter 28 body.

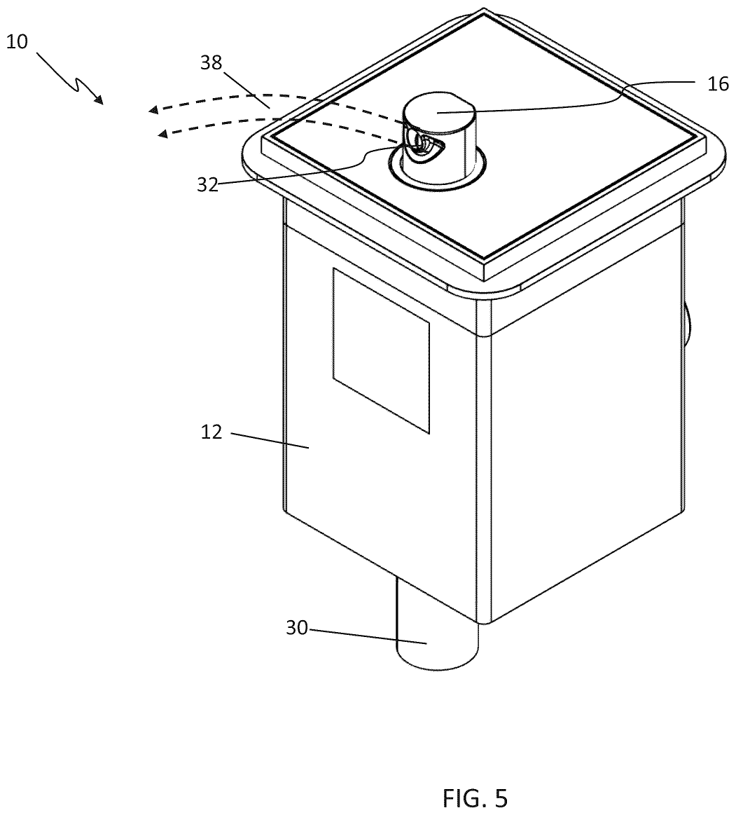

FIG. 5 illustrates an isometric view of a deck jet assembly 10 in accordance with the present disclosure. As shown, the pop-up nozzle 16 is in the extended or active position, where water exiting may exit from the spout 32 of the pop-up nozzle 16 in a laminar flow 38 as previously discussed. FIG. 5 contains many of the same features, structures, and functions as described relative to FIGS. 1-3, which are not restated for FIG. 5 for brevity in disclosure.

With reference to FIGS. 1-5, the deck jet assembly 10 may be made of any material that is commonly used in association with pools, lighting features, and water features. This includes plastic, stone, concrete, plaster, metal, composite materials, or treated wood. In some cases, the different components of the deck jet assembly 10 may be made of different materials. For example, most of the housing 12 itself may be of a plastic or metal material, but the portion of the housing 12 having the pop-up nozzle 16, and thus, the portion of the housing 12 visible to a user, may be made of a more aesthetic material or have a vinyl layer attached thereto. Similarly, internal components of the housing 12 such as the inlet pipe 14, pop-up nozzle 16, lighting device 18, electrical conduit 20, funnel 22, connector pipe 24, gasket 26, and filter 28 may be made of a different material than that of the housing 12. Internal components of the deck jet assembly 10 may preferably be made of a plastic, metal, or composite material, as the case may be for durability, ease of repair, ease of manufacture, and cost efficiencies.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure.

What is claimed is:

1. A deck jet assembly comprising:
a pop-up nozzle configured to receive a quantity of water from an inlet pipe; and
a lighting device positioned substantially directly below the pop-up nozzle, wherein the lighting device is positioned to emit a quantity of light to illuminate a laminar flow through the pop-up nozzle.

2. The deck jet assembly of claim 1, further comprising a housing, wherein the inlet pipe, the lighting device, and the pop-up nozzle interface with the housing.

3. The deck jet assembly of claim 2, wherein the pop-up nozzle has a retracted state and a deployed state, wherein in the deployed state, the pop-up nozzle extends beyond an exterior surface of the housing a predetermined distance.

4. The deck jet assembly of claim 3, wherein the pop-up nozzle sits substantially flush with an upper surface of a pool deck when the pop-up nozzle is in the retracted state.

5. The deck jet assembly of claim 2, wherein the housing is positionable at least partially below an upper surface of a pool deck.

6. The deck jet assembly of claim 2, the housing further comprising an upper portion connected to a lower portion by a gasket, wherein the upper portion contains a rim positionable at least partially below an upper surface of a pool deck, and wherein the upper portion of the housing is separable from the lower portion of the housing along the gasket.

7. The deck jet assembly of claim 6, further comprising a decking layer positioned above the upper portion of the housing and substantially level with the upper surface of the pool deck.

8. The deck jet assembly of claim 1, wherein a portion of the quantity of light emitted from the lighting device illuminates the laminar flow along at least a portion of a length thereof.

9. The deck jet assembly of claim 1, further comprising a funnel connected to an internal sidewall of a housing, wherein the funnel directs the quantity of water from an inlet pipe into the housing and toward the pop-up nozzle.

10. The deck jet assembly of claim 9, further comprising a filter positioned within the housing between the inlet pipe and the funnel, wherein the filter forms the laminar flow with the quantity of water, wherein the laminar flow extends beyond the pop-up nozzle.

11. The deck jet assembly of claim 10, the filter further comprising an opening configured to receive at least one of the lighting device or an electrical wire electrically connected to the lighting device.

12. The deck jet assembly of claim 9, wherein a filter is positioned within a portion of the funnel, wherein the filter forms a laminar flow with the quantity of water, wherein the laminar flow extends beyond the pop-up nozzle.

13. A deck jet system for lighting a pool deck, comprising:
an inlet pipe configured to receive a quantity of water;
a pop-up nozzle fluidically connected to the inlet pipe;
a lighting device positioned substantially directly below the pop-up nozzle, wherein the lighting device is positioned to emit a quantity of light to illuminate a laminar flow through the pop-up nozzle; and
a housing, wherein the inlet pipe, the lighting device, and the pop-up nozzle interface with the housing, wherein the pop-up nozzle has a retracted state and a deployed state, wherein in the deployed state, the pop-up nozzle extends beyond an exterior surface of the housing a predetermined distance.

14. The deck jet system of claim 13, wherein the laminar flow extends beyond the pop-up nozzle when the pop-up nozzle is in the deployed state.

15. The deck jet system of claim 13, further comprising:
a funnel connected to an internal sidewall of a housing, wherein the funnel directs the quantity of water from the inlet pipe into the housing and toward the pop-up nozzle; and
a filter positioned within the housing between the inlet pipe and the funnel, wherein the filter forms the laminar flow with the quantity of water, wherein the laminar flow extends beyond the pop-up nozzle.

16. The deck jet system of claim 15, the filter further comprising an opening configured to receive at least one of the lighting device or an electric wire electrically connected to the lighting device.

17. The deck jet system of claim 13, the housing further comprising an upper portion connected to a lower portion by a gasket, wherein the upper portion contains a rim positionable at least partially below an upper surface of a pool deck, and wherein the upper portion of the housing is separable from the lower portion of the housing along the gasket.

18. A system to light pool water features, comprising:
a single water source fluidly connecting a first deck jet assembly to a second deck jet assembly, wherein at least one of the first deck jet assembly or the second deck jet assembly further comprises:
an inlet pipe configured to receive water from the single water source;
a pop-up nozzle fluidically connected to the inlet pipe; and
a lighting device positioned substantially directly below the pop-up nozzle,
wherein the lighting device is positioned to emit a quantity of light to illuminate a laminar flow through the pop-up nozzle.

19. The system of claim 18, wherein the single water source is fluidly connected to the first deck jet and the second deck jet in series.

20. The system of claim 18, further comprising a parallel fluid connection between the single water source and the first deck jet and the second deck jet.
